(19) United States
(12) Patent Application Publication
(10) Pub. No.: US 2009/0161897 A1
(43) Pub. Date: Jun. 25, 2009

(54) Electroacoustic miniature converter with retaining means for installation in a hearing device

(75) Inventors: Wemer Fickweiler, Bubenreuth (DE); Markus Trautner, Nurnberg (DE); Tom Weidner, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Instruments Pte. Ltd.

(21) Appl. No.: 12/317,058

(22) Filed: Dec. 18, 2008

(30) Foreign Application Priority Data
Dec. 19, 2007 (DE) 10 2007 061 310.7

(51) Int. Cl. H04R 25/00

(52) U.S. Cl. 381/322

(57) ABSTRACT

An electroacoustic miniature converter for hearing devices is described. This includes a polyhedral housing module and an elastic retaining device, with the housing module and the retaining device being embodied such that the retaining device is connected to exclusively one single surface of the housing module.

### CROSS REFERENCE TO RELATED APPLICATIONS

This application claims priority of German application No. 10 2007 061 310.7 DE filed Dec. 19, 2007, which is incorporated by reference herein in its entirety.

### FIELD OF INVENTION

The invention relates to an electroacoustic miniature converter, a holding frame as and hearing devices.

### BACKGROUND OF INVENTION

Electroacoustic miniature converters are used to convert acoustic signals into electrical signals and to convert electrical signals into acoustic signals. With numerous applications, like for instance hearing devices, an acoustic signal is recorded by an electroacoustic miniature converter (microphone) and processed, and an acoustic signal is output by an electroacoustic miniature converter (receiver, loudspeaker). To avoid feedback between the receiver and microphone, the output sound of the receiver must be prevented from being received by the microphone.

With electroacoustic devices, in addition to the direct sound transmission between the receiver and the microphone, there is a second way of transmitting signals. The receiver can thus also radiate sound by means of vibrations of the receiver housing. Conversely, the microphone also records structure-borne sound across its housing. In order to avoid this parasitic sound transmission, attempts are made to position the receiver and microphone as spatially far apart from one another in the hearing device housing as possible. The advancing miniaturization of hearing devices thus sets narrow boundaries for this spatial separation. Attempts are thus made to mount electroacoustic miniature converters in a “floating” fashion, so that they do not transmit any structure-borne sound to housing parts.

To this end, WO 01/43498 A1 discloses a solution, with which a rubber collar surrounds a support of a receiving unit of a hearing device in a cylindrical fashion.

DE 691 11 668 T2 also discloses arranging a microphone of a hearing device in an elastic attachment sleeve, which surrounds ⅔ of the microphone housing.

DE 102 14 187 C1 describes a support of an electroacoustic miniature converter with a first and a second elastic retaining element, with the first retaining element only being fastened in a central region of the housing front side and the second retaining element only being fastened in a central region of the housing rear side on the housing of the electroacoustic miniature converter.

DE 100 43 201 C1 also discloses an electroacoustic miniature converter with a first housing for encasing a second housing. To retain and fix the first housing within the second housing, an elastic element which is connected to the two housings, is located between the two housings.

DE 198 31 771 A1 also discloses a plastic casing for an acoustic converter and a method for the production thereof.

### SUMMARY OF INVENTION

The relatively large space requirement, which prevents further miniaturization, is disadvantageous with the afore-mentioned solutions.

It is an object of the invention to overcome this disadvantage and to specify a further electroacoustic miniature converter with an elastic retaining device, which requires less installation space in a housing and is easy to manufacture.

The object is achieved with the devices of the independent claims.

The device has an electroacoustic miniature converter for hearing devices with a polyhedral housing module and an elastic retaining means. A polyhedral housing module can take the form of a polyhedron for example, the edges of which are rounded. The retaining means is formed with a first material. The housing module and the retaining means are embodied such that the retaining means is exclusively connected to the front face of the housing module.

This is advantageous in terms of its minimal installation size and its suitability to further miniaturization.

In one development, the first material can be made of rubber and the retaining means can be vulcanized on the housing module.

As a result, a fixed connection can be easily established between the housing module and the retaining means.

In a further embodiment, the first material can consist of a thermoplastic elastomer and the retaining means can be injection-molded onto the housing module.

The advantage here is that elastomers can also be easily used.

In one development, the retaining means can be adhered to the housing module.

As a result, connecting the retaining means and the housing module results in no thermal damage to components of the miniature converter.

In a further embodiment, the housing module can be embodied in the manner of a cuboid.

The simple production and space-saving design is advantageous.

In one development, the retaining means can comprise an opening and can be connected to the housing module such that the opening of the retaining means is aligned with a sound-permeable opening of the housing module.

As a result, sound is able to enter and exit the miniature converter in an unhindered fashion.

In one development, the miniature converter can include a membrane and at least one electrical component.

The miniature converter can also be a microphone or a loudspeaker.

A holding frame for fastening an electroacoustic miniature converter is also specified. In this way, the holding frame is embodied such that the retaining means is fastened in an opening of the holding frame.

This is advantageous in that it is then easy to insert it into a hearing device housing.

The invention also claims a hearing device with an electroacoustic miniature converter and with a hearing device housing.

The invention also claims a hearing device with an electroacoustic miniature converter, a hearing device housing and an holding frame which can be connected to the hearing device housing.

### BRIEF DESCRIPTION OF THE DRAWINGS

Further features of the invention are obvious from the description below of an exemplary embodiment with reference to schematic drawings, in which;

FIG. 1: shows a microphone with retaining means according to the prior art,

FIG. 2: shows a sectional view through a microphone with retaining means according to the prior art,

FIG. 3: shows a microphone with retaining means,

FIG. 4: shows a microphone with retaining means mounted in a housing frame and

FIG. 5: shows a microphone with retaining means in a hearing device housing.

### DETAILED DESCRIPTION OF INVENTION

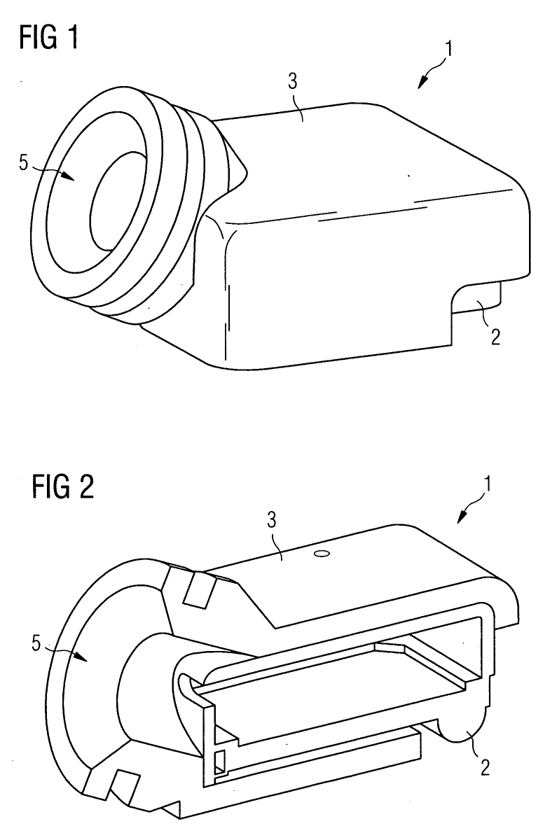

FIG. 1 shows a microphone 1 as one solution from the prior art, which includes an elastic retaining means 3 and a housing module 2 retained therein. With the opening 5 embodied in the retaining means 3 and the cylindrical collar formed therearound, the microphone can be elastically connected to a hearing device housing in a manner that inhibits structure-borne sound. The retaining means 3 almost completely surrounds the cuboid housing module 2.

FIG. 2 shows a perspective sectional view of the microphone 1 from FIG. 2. It is clear that the retaining means 3 almost completely surrounds the housing module 2. The final thickness of the retaining means 3 consequently increases the required installation volume by 30 to 50% as a result of this construction.

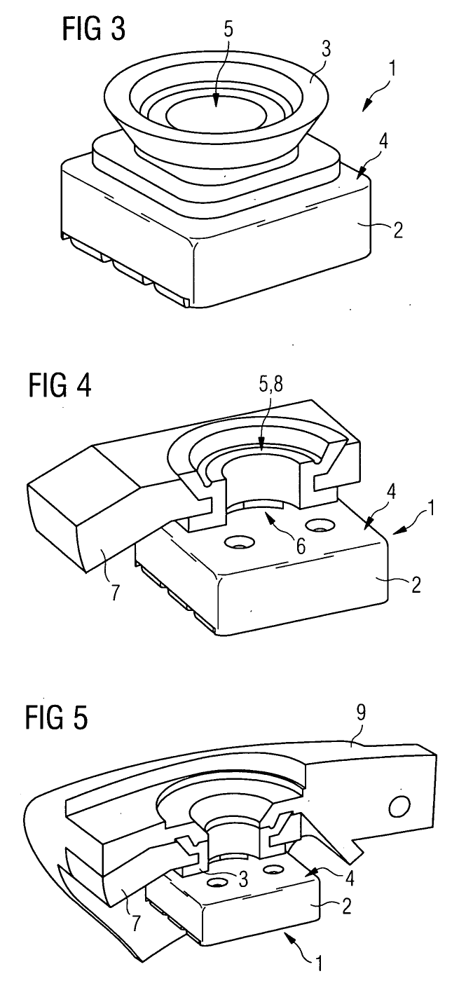

FIG. 3 shows a perspective view of an electroacoustic miniature converter 1, for instance a microphone. An elastic retaining means 3 is positioned on a polyhedral housing module 2, in which the electroacoustic components are accommodated. The retaining means 3 can be formed using rubber or using a plastic. Said means can be vulcanized, injection-molded or adhered to the housing module 2. It is clear that the retaining means is exclusively connected to a surface 4 of the housing module 2. The opening 5 of the retaining means 3 rests precisely across the opening 6 of the housing module 2 (not visible) in order not to prevent sound propagation.

FIG. 4 shows the microphone 1 from FIG. 3 in a perspective sectional view installed in a holding frame 7. The retaining means 3 attached to only one surface 4 of the housing module 2 is fitted into an opening 8 of the holding frame 7 such that all openings 5, 6, 8 come to rest one above the other. No interfering structure-borne sound can be transmitted from the holding frame 7 to the microphone 1 between the holding frame 7 and the microphone 1 as a result of elastically attaching the retaining means 3.

The electroacoustic miniature converter 1 installed in a hearing device housing 9 from FIGS. 3 and 4 is shown in a perspective sectional view in FIG. 5. The electroacoustic miniature converter 1 is connected to the hearing device housing 9 by means of a holding frame 7 and a retaining means 3, which is fastened to an end on the housing module 2 and to the other end on the holding frame 7. The elastic attachment allows the structure-borne sound of the hearing device housing 9 to be significantly attenuated. The minimal space requirement of the miniature converter 1 is apparent here.

1.-11. (canceled)

12. An electroacoustic miniature converter for hearing devices, comprising:
a polyhedral housing module; and
an elastic retaining device having a first material, wherein the retaining device is exclusively connected to a front face of the housing module.

13. The electroacoustic miniature converter as claimed in claim 12, wherein the first material is rubber and the retaining device is vulcanized on the housing module.

14. The electroacoustic miniature converter as claimed in claim 12, wherein the first material consists of a thermoplastic elastomer and the retaining device is injection-molded onto the housing module.

15. The electroacoustic miniature converter as claimed in claim 12, wherein the retaining device is formed with rubber and is adhered to the housing module.

16. The electroacoustic miniature converter as claimed in claim 12, wherein the retaining device is formed with a thermoplastic elastomer and is adhered to the housing module.

17. The electroacoustic miniature converter as claimed in claim 12, wherein the housing module is a cuboid.

18. The electroacoustic miniature converter as claimed in claim 12, wherein the retaining device includes an opening and is connected to the housing module such that the opening of the retaining device corresponds to a sound-permeable opening of the housing module.

19. The electroacoustic miniature converter as claimed in claim 13, wherein the retaining device includes an opening and is connected to the housing module such that the opening of the retaining device corresponds to a sound-permeable opening of the housing module.

20. The electroacoustic miniature converter as claimed in claim 14, wherein the retaining device includes an opening and is connected to the housing module such that the opening of the retaining device corresponds to a sound-permeable opening of the housing module.

21. The electroacoustic miniature converter as claimed in claim 15, wherein the retaining device includes an opening and is connected to the housing module such that the opening of the retaining device corresponds to a sound-permeable opening of the housing module.

22. The electroacoustic miniature converter as claimed in claim 16, wherein the retaining device includes an opening and is connected to the housing module such that the opening of the retaining device corresponds to a sound-permeable opening of the housing module.

23. The electroacoustic miniature converter as claimed in claim 12, wherein the miniature converter includes a membrane and at least one electrical component.

24. The electroacoustic miniature converter as claimed in claim 12, wherein the converter is a microphone.

25. The electroacoustic miniature converter as claimed in claim 12, wherein the converter is a loudspeaker.

26. A holding frame for fastening an electroacoustic miniature converter for hearing devices having a polyhedral housing module and an elastic retaining device having a first material, wherein the retaining device is exclusively connected to a front face of the housing module, and wherein the retaining device is fastened in an opening of the holding frame.

27. The holding frame as claimed in claim 26, wherein the retaining device includes an opening and is connected to the housing module such that the opening of the retaining device corresponds to a sound-permeable opening of the housing module.

28. A hearing device, comprising:
an electroacoustic miniature converter with a polyhedral housing module and an elastic retaining device having a first material, wherein the retaining device is exclusively connected to a front face of the housing module; and
a hearing device housing.

29. The hearing device as claimed in claim 28, further comprising:
a holding frame, wherein the retaining device is fastened in an opening of the holding frame.

30. The hearing device as claimed in claim 28, wherein the retaining device includes an opening and is connected to the housing module such that the opening of the retaining device corresponds to a sound-permeable opening of the housing module.
